(19) United States
(12) Patent Application Publication
(10) Pub. No.: US 2014/0191515 A1
(43) Pub. Date: Jul. 10, 2014

(54) Magnetic-pin catch for cabinet or interior room door

(71) Applicant: Edward Gorlewski, Brick, NJ (US)

(72) Inventor: Edward Gorlewski, Brick, NJ (US)

(21) Appl. No.: 13/735,313

(22) Filed: Jan. 7, 2013

(51) Int. Cl. E05C 1/08

(52) U.S. Cl. CPC E05C 1/08
USPC 292/138

(57) ABSTRACT

A catch member within one of a movable door or fixed jamb head or frame for the door, cooperates with a probe member within the other one of the movable door or fixed jamb head or frame for the door in closing and opening the door via attracting forces between an embedded rare earth magnet in one with respect to a steel pin in the other in a construction wherein both the magnet and the pin are hidden from view when the door is open or closed—in presenting a more attractive appearance in high-end interior door constructions and high-end fashionable cabinetry installations.

### CROSS-REFERENCE TO RELATED APPLICATIONS

A Provisional patent application covering the invention described herein was filed Jan. 17, 2012, and assigned Ser. No. 61/631,997.

### STATEMENT REGARDING FEDERALLY SPONSORED RESEARCH OR DEVELOPMENT

Research and development of this invention and application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to door latching devices, in general, and to such devices for high-end interior room and cabinet door designs, in particular.

2. Description of the Related Art

Latching devices for interior room doors typically include a shaft which extends from a door knob to fit within an opening of a strike plate attached to the door jamb. As is well known and understood, maintenance is often required as the latch has a tendency to stick over time so the door is difficult to remain closed; likewise, the screws holding the knob to the door themselves loosen with continued use and the door frequently loses alignment. However, even when operating as intended, the latching mechanism and strike plate are visible and exposed when the door is ajar. Similarly, with the magnetic or bullet catches employed in cabinetry, those, too, are exposed when the cabinet is opened, even where their operations of securement and release are as intended. For high-end interior door constructions, and for high-end fashionable cabinetry installations, it would be desirable if they could remain out-of-sight when the doors are open.

### OBJECTS OF THE PRESENT INVENTION

It is an object of the present invention, therefore, to provide such a new and improved latching mechanism for interior room and cabinet door installations where such mechanisms are substantially hidden.

It is an object of the invention, also, to provide this latching mechanism whose manner of operation essentially remains the same over an extended period of use, thereby requiring a far lesser degree of maintenance.

It is another object of the invention, furthermore, to provide a new and improved latching mechanism which can be easily installed to begin with, reducing the time and effort required to set them to proper operation.

It is another object of the invention to provide a single type of latching mechanism which can be used both for interior room door and cabinet door installations alike.

### SUMMARY OF THE INVENTION

As will become clear from the following description, the latching mechanism of the present invention consists of a device having a downwardly facing catch member within a door jamb or frame, along with an upwardly facing probe member within a top surface of a movable door. In a preferred embodiment, the catch member has an open bottom end, a closed top end, and an embedded rare earth magnet affixed inwardly of the closed top end—along with the probe member having a steel pin within a nonmagnetic shell having an open top end and a closed bottom end. In accordance with the teachings of the latching device, the probe member pin is sized to move upwardly within the nonmagnetic shell into the catch member under the attracting forces of the embedded rare earth magnet.

To facilitate the upward movement of the probe member steel pin, the pin is of a downwardly tapering dome shape, with the tapering extending on either side of the pin. Where the catch member is embedded within an underside of an interior door frame and the probe member is embedded within a top surface of a movable interior room door, pushing the movable door to align the steel pin with the embedded rare earth magnet of the catch member secures the movable door closed. Pulling of the movable door thereafter to align a tapering portion of the steel pin with the embedded rare earth magnet then releases the movable door to open. As will also be seen, where the catch member is embedded within an underside of a cabinet frame and where the probe member is embedded within a top surface of a movable door, the securement and release in a cabinet door installation through pushing and pulling movements operate in a like manner.

A preferable composition of neodymium alloy for the embedded rare earth magnet within a circular aperture drilled within the underside of the door jamb head or frame allows an easy and simple installation when the nonmagnetic shell (with its included steel pin) is sized to seat within a circular aperture similarly drilled within the top surface of the movable door.

### BRIEF DESCRIPTION OF THE DRAWINGS

These and other features of the invention will be more clearly understood from a consideration of the following description, taken in connection with the accompanying drawings, in which:

FIG. 1 is a pictorial view of a door jamb head or frame illustrating the location of the catch member and probe member within a door understood to be open and ajar;

FIG. 2 is a pictorial view of a door jamb head or frame illustrating the location of the catch member and probe member within a door understood to be in a closed position;

FIGS. 3a and 3b are perspective left (or right) side mirror image views and a rear bottom view, respectively, of the steel pin of the probe member of the invention;

FIGS. 4a, 4b and 4c are perspective, front and rear views, respectively, of the nonmagnetic shell of the probe member;

FIG. 5 is a perspective view of the catch member of the latching device; and

FIG. 6 is a pictorial view of the magnetic-pen catch constructed in accordance with a preferred embodiment of the invention.

### DETAILED DESCRIPTION OF THE INVENTION

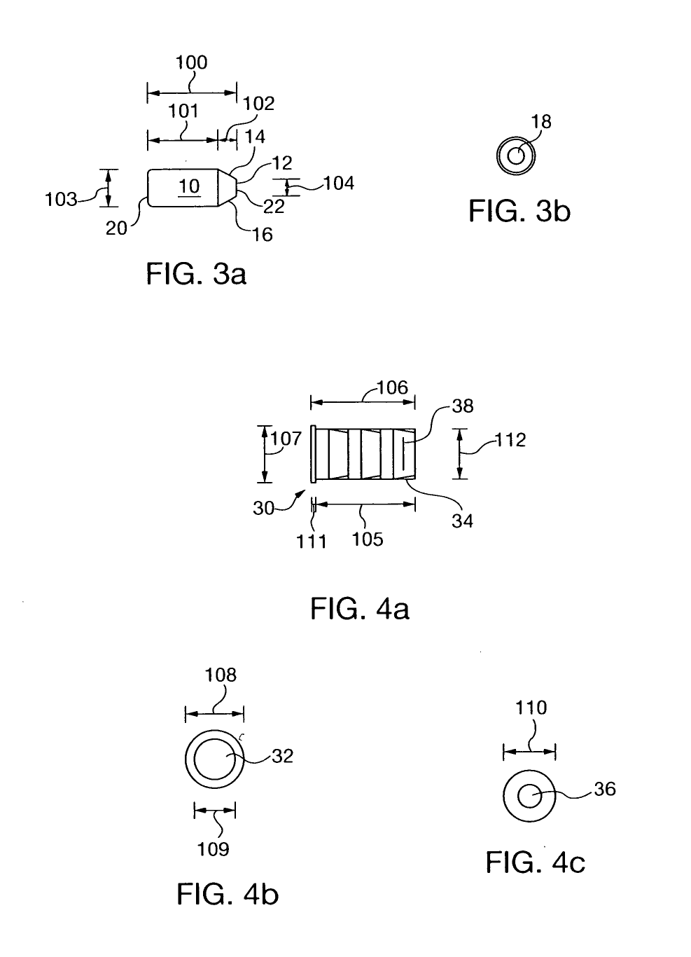

The probe member steel pin of the latching device of FIGS. 3a and 3b is shown at 10, as being of a downwardly tapering dome shape 12 offset from the center of the steel pin 10, along with downwardly tapering sides 14, 16 on either side. The steel pin 10 has an aperture hole 18 at its bottom end 20. Provided with a polished tip 22 at the dome shape 12, the following dimensions have proved useful in a preferred construction of the pin:
Dimension 100 . . . 0.875 inches
Dimension 101 . . . 0.6875 inches
Dimension 102 . . . 0.1875 inches
Dimension 103 . . . 0.375 inches
Dimension 104 . . . 0.125 inches
   The tapering of the sides 14,16 are composed of a 0.875 inch radius. The hole at 18 is 0.375 inches deep.

The nonmagnetic shield 30 of FIGS. 4a, 4b and 4c receiving the steel pin 10 has its own bore 32 and its own barb 34. The dimensions for the nonmagnetic shell body in a preferred embodiment of the invention is as follows:
Dimension 105 . . . 1.000 inches
Dimension 106 . . . 1.03125 inches
Dimension 107 . . . 0.5625 inches
Dimension 108 . . . 0.5625 inches
Dimension 109 . . . 0.390 inches
Dimension 110 . . . 0.507 inches
Dimension 111 . . . 0.03125 inches

The bore 32 in FIG. 4b is “stopped” 0.125 inch from the bottom of the nonmagnetic shell, which also is provided with an aperture hole 36 with a diameter of 0.1875 inch. The bottom of the bore is shown at 38, the Dimension 112 of 0.507 inch representing the widest point of the barb.

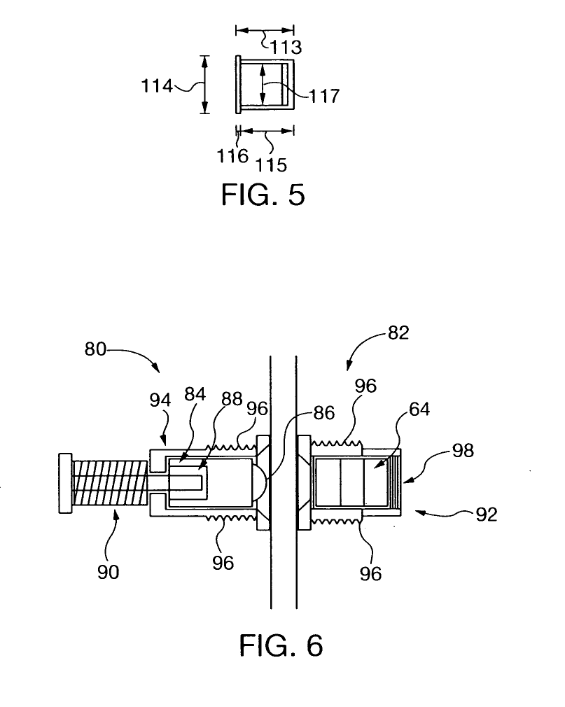

In the catch member of FIG. 5, the dimensions preferably utilized in its construction is similarly as follows:
Dimension 113 . . . 0.5625 inches
Dimension 114 . . . 0.5625 inches
Dimension 115 . . . 0.53125 inches
Dimension 116 . . . 0.03125 inches
Dimension 117 . . . 0.390 inches

The bottom of the bore 40 is 0.1250 inch from the bottom, into which space the embedded rare earth magnet (preferably a neodymium alloy) is inserted.

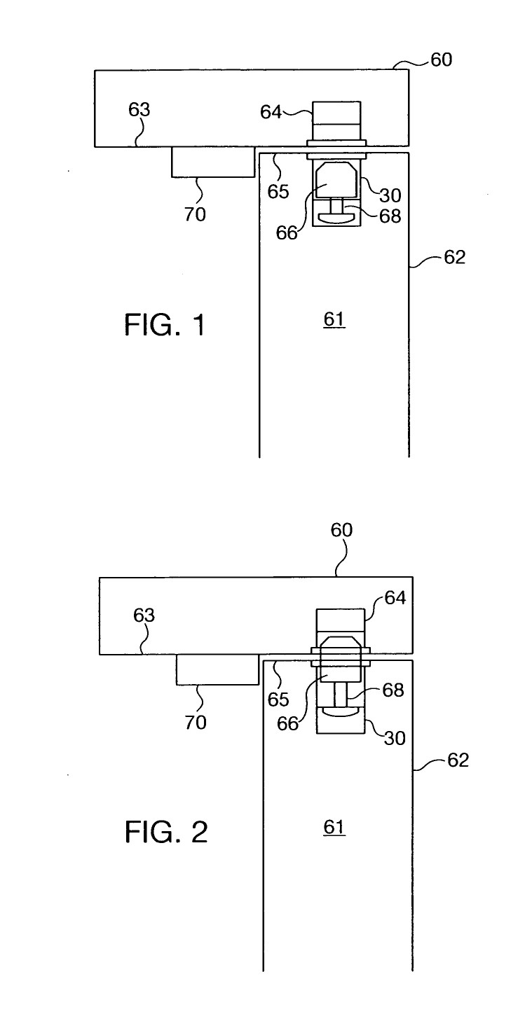

In FIGS. 1 and 2, the door jamb head or frame is shown at 60 and the face of the interior room or cabinet door 61 is shown at 62. The catch member of FIG. 5 is sized to seat within a circular aperture drilled upwardly within the underside of the door jamb head or frame as at 63, with the embedded rare earth magnet affixed inwardly within the enclosed end of the catch member, as at 64. At the same time, the nonmagnetic shell of the probe member (FIGS. 3a, 3b and 4a, 4b, 4c) is sized to seat within a circular aperture drilled downwardly within the top surface of the movable door 61 as at 65. The steel pin 10 of the probe member is repeated at 66, with its polished tip 22 facing upwardly, along with a pull 68 fitted within a nylon insert fitted into the hole 18 at the bottom end of the pin. With a door stop identified at 70, pushing the movable door 61 to align the steel pin 10 with the embedded rare earth magnet 64 of the catch member as in FIG. 2 secures the movable door closed by the forces of magnetic attraction between the two; on the other hand, pulling the movable door 61 to align the tapering portion of the steel pin with the embedded rare earth magnet (as in FIG. 1) releases the attraction in allowing the movable door 61 to open.

FIG. 6 illustrates the door side at 80 and the jamb side at 82. The steel dome pin of the invention is shown at 84 with a preferred rounded tip 86 instead of the flat portion polished tip 22 of FIG. 3a. A nylon friction insert 88 operates with a return spring 90, with the catch and probe members 92, 94 being respectively threaded at 96. The embedded rare earth magnet 64 is seated within a threaded cap 98.

As will be appreciated by those skilled in the art, the installation and operation of the latching device described thus maintains both the catch member and the probe member hidden from view when the door is open—be it an interior room door or a cabinet door. Easy installation follows simply by drilling the circular apertures in the underside of the jamb head or frame on the one hand, and in the top surface of the movable door on the other hand once the sizing of the catch member and probe member is selected. With the attracting forces provided between the embedded rare earth magnet and the steel pin, the closure and release operations between the two are maintained over time, thus requiring little maintenance of the latching device performance. Essentially with a steel pin being of cylindrical configuration of a ⅜ inch diameter sized to fit with a clearance of ⅛ inch within the nonmagnetic shield, and with the width of the embedded neodymium magnet being some ⅛ inch greater than the diameter of the steel pin, a latching mechanism results (according to the invention) in providing a single type of latching mechanism which can be used both for interior room door and cabinet door installations alike, while being hidden from view.

While there has been described what is considered to be a preferred embodiment of the present invention, it will be readily appreciated by those skilled in the art that modifications can be made without departing from the scope of the teachings herein. For example, whereas the invention has been described in the context of an upwardly facing probe member within a top surface of a movable door and with a downwardly facing catch member within a door jamb head or frame, it will be understood that the two orientations could be reversed (or even placed in a side-to-side orientation between a door edge and the door jamb with or without a biasing spring return for the steel pin), and the operation continue as before, with the steel pin being drawn into the catch under the attracting forces of the rare earth magnet when the door is pushed to close, and released therefrom when the door is pulled to open. Additionally, whereas both the steel pin and nonmagnetic shell are described as being installed within a circular latching device of the invention, bore configurations other than cylindrical can be utilized instead without affecting the attractive-release operation between the 2 component parts. And whereas the preferred embodiment of the invention illustrated by FIG. 6 may be constructed with the downwardly tapering dome having a rounded tip portion 86, testing has shown that improved, although somewhat lesser performance can still be had with a steel pin 10 with a flat portion tip 22. For at least such reasons, therefore, resort should be had to the Claims appended hereto for a true understanding of the scope of the invention.

I claim:

1. The combination comprising:
a movable door;
a fixed jamb head or frame for said door;
an orientingly facing catch member within one of said door and said fixed jamb head or frame;
an oppositely orientingly facing probe member within said other of said door and said fixed jam head or frame;
with the catch member having an open first end, a closed second end, and an embedded rare earth magnet affixed inwardly of said closed second end;
with the probe member having a steel pin within a nonmagnetic shell having an open first end and a closed second end; and
wherein the probe member pin is sized to move freely within the nonmagnetic shell into the catch member under the attracting forces of the embedded rare earth magnet.

2. The combination of claim 1 wherein the movable door constitutes an interior room door, wherein the catch member is embedded within an underside of said jamb head or frame for said door, and wherein the probe member is embedded within a top surface of said door.

3. The combination of claim 1 wherein the movable door constitutes a cabinet door, wherein the catch member is embedded within an underside of said jamb or frame for said door, and wherein the probe member is embedded within a top surface of said door.

4. The combination of claim 1 wherein a top surface of the steel pin is of a downwardly tapering, rounded dome shape.

5. The combination of claim 4 wherein the downward tapering of the rounded dome shape of the steel pin extends on either side of the steel pin.

6. The combination of claim 1, wherein a top surface of the steel pin is of a downwardly tapering, rounded dome shape, wherein the downward tapering of the rounded dome shape of the steel pin extends on either side of the steel pin, and wherein pushing said movable door to align the steel pin with the embedded rare earth magnet of the catch member secures said movable door closed and wherein pulling said movable door to align a tapering portion of the steel pin with the embedded rare earth magnet releases said movable door to open.

7. The combination of claim 6 wherein the catch member is sized to seat within an aperture drilled within an underside of the jamb head or frame for said door and wherein the probe member is sized to seat within an aperture drilled within said top surface of said door.

8. The combination of claim 1 wherein the embedded rare earth magnet is composed of a neodymium alloy.

9. The combination of claim 8 wherein the probe member includes a steel pin of cylindrical configuration of ⅜ inch diameter sized to fit with a clearance of ⅛ inch within said nonmagnetic shell.

10. The combination of claim 9 wherein the width of the embedded rare earth magnet is ⅛ inch greater than the diameter of the steel pin.

11. The combination of claim 1 wherein a top surface of the steel pin is of a downwardly tapering, dome shape with a flat portion tip.

12. The combination of claim 11 wherein the tapering of the dome shape of the steel pin extends on either side of the flat portion of the steel pin.

13. The combination of claim 1, wherein a top surface of the steel pin is of a downwardly tapering dome shape, wherein the tapering of the dome shape of the steel pin extends on either side of a flat portion of the steel pin, and wherein pushing said movable door to align the flat portion of the steel pin with the embedded rare earth magnet of the catch member secures said movable door closed and wherein pulling said movable door to align a tapering portion of the steel pin with the embedded rare earth magnet releases said movable door to open.

14. The combination of claim 13 wherein the catch member is sized to seat within an aperture drilled within an underside of the jamb head or frame for said door and wherein the probe member is sized to seat within an aperture drilled within said top surface of said door.

15. The combination of claim 14 wherein the probe member includes a steel pin of cylindrical configuration of ⅜ inch diameter sized to fit with a clearance of ⅛ inch within said nonmagnetic shell.

16. The combination of claim 15 wherein the width of the embedded rare earth magnet is ⅛ inch greater than the diameter of the steel pin.
